(19) United States
(12) Patent Application Publication
(10) Pub. No.: US 2018/0303270 A1
(43) Pub. Date: Oct. 25, 2018

(54) COFFEE EXTRACTION DEVICE AND PRODUCTION METHOD

(71) Applicant: Masahiro IIZUKA, Tokyo (JP)

(72) Inventor: Masahiro IIZUKA, Tokyo (JP)

(21) Appl. No.: 15/768,560

(22) PCT Filed: Oct. 16, 2015
(86) PCT No.: PCT/JP2015/079315

§ 371 Date: Apr. 16, 2018

(51) Int. Cl. A47J 31/06

(52) U.S. Cl. CPC A47J 31/0605

(57) ABSTRACT

The present invention provides a device and a coffee production method which are capable of extracting coffee from which an unfavorable taste is removed as much as possible. There is provided a coffee extraction device including an extractor that has a hollow portion which has an internal space for containing a liquid, a bottom portion which is disposed below the hollow portion, and a tube portion which ascends from the bottom portion and descends again so as to discharge the liquid to a lower portion of the bottom portion, and a filter portion that is capable of filtering ground coffee beans, and that has an engagement portion for engaging with the extractor in order to be placed at a predetermined position from the bottom portion of the extractor. The filter portion is placed in the hollow portion of the extractor so that the tube portion achieves a siphon effect.

### TECHNICAL FIELD

The present invention relates to a beverage extraction device, and particularly relates to a device for extracting coffee from which an unfavorable taste is removed as much as possible, and a coffee production method using the device.

### BACKGROUND ART

As a method of extracting coffee extract from moderately roasted and ground coffee beans, a so-called dripping method or a cold brew method is known. According to the above-described dripping method, hot water is used. Accordingly, a coffee aroma dissipates, or a sour taste is strong. Furthermore, in some cases, oil flowing out when the coffee beans are roasted may be extracted, and a drinking person may receive an impression that coffee is too oily.

On the other hand, the cold brew method in the related art is the so-called dripping method, and the coffee is extracted using a permeation method. Accordingly, the cold brew method has the following characteristics. The drinking person feels a pleasant aroma and a sweet taste from the ground coffee beans. Caffeine and tannin are less likely to elute and a bitter taste is softened. However, an extremely small amount of water is dripped at room temperature. Consequently, there is a problem in that it takes time to extract the coffee extract.

In this way, the above-described disadvantage remains even in the cold brew method. Accordingly, it is preferable to alleviate this disadvantage as much as possible.

Therefore, Japanese Unexamined Patent Publication No. H08-154833 discloses a coffee liquid extraction device as follows. The device has an extractor for dripping a coffee liquid by mounting a filter paper and adding roasted and ground coffee bean powder, a dual purpose receiving container which is placed below the extractor so as to hold water for extraction and to receive the coffee liquid falling from the extractor, a circulation path and a circulation pump for transporting the liquid contained inside the dual purpose receiving container to above the extractor so as to pour the liquid into the extractor, and a circulating water heater disposed in the middle of the circulation path. The device further has a control unit that drives the circulation pump for a prescribed period of time by turning on an extraction switch so as to circulate the liquid, and that pours water heated to high temperature into the extractor by turning on the circulating water heater for a prescribed period of time which is limited at an operation initial stage.

According to the coffee liquid extraction device, the water heated to the high temperature by turning on the circulating water heater for the prescribed period of time is poured into the extractor. Accordingly, the coffee can be extracted within a relatively short time. This device is regarded as a compromise proposal between the dripping method and the cold brew method. Accordingly, the device is provided with both characteristics. However, a problem has not yet been solved in that the drinking person feels an unfavorable taste from the extracted coffee.

### CITATION LIST

### Patent Literature

Patent Literature 1: Japanese Unexamined Patent Publication No. H08-154833

### SUMMARY OF INVENTION

### Technical Problem

The present invention is made in view of the above-described points, and aims to provide a device which can extract coffee extract from which an unfavorable taste is removed as much as possible, and a coffee production method using the device.

### Solutions to Problem

The present inventor has focused on a process for extracting a coffee extract, and has intensively researched which process most affects an unfavorable taste. As a result, the inventor found out that the unfavorable taste is mixed into coffee extract extracted at a final extraction stage, that is, immediately before water is completely dripped. In this regard, the inventor has developed a device in which a possibility that the coffee extract extracted at the final stage may be mixed with the previously extracted coffee extract is minimized as much as possible, and a coffee production method using the device.

According to a first aspect, there is provided a coffee extraction device including an extractor that has a hollow portion which has an internal space for containing a liquid, a bottom portion which is disposed below the hollow portion, and a tube portion which ascends from the bottom portion and descends again so as to discharge the liquid to a lower portion of the bottom portion, and a filter portion that is capable of filtering ground coffee beans, and that has an engagement portion for engaging with the extractor in order to be placed at a predetermined position from the bottom portion of the extractor. The filter portion is placed in the hollow portion of the extractor so that the tube portion achieves a siphon effect.

According to the coffee extraction device in a second aspect, in the first aspect, a dripping device for dripping water at a regular interval is placed in the filter portion placed inside the extractor.

According to the coffee extraction device in a third aspect, in the first aspect or the second aspect, an air mixing device capable of mixing air into the liquid is disposed downstream of the coffee extraction device.

According to the coffee device in a fourth aspect, in the third aspect, in a lower portion of the mixing device capable of mixing the air into the liquid, the coffee extraction device further includes a second extractor that has a hollow portion which has an internal space for containing a liquid, a bottom portion which is disposed below the hollow portion, and a tube portion which ascends from the bottom portion and descends again so as to discharge the liquid to a lower portion of the bottom portion, and a second filter portion that is capable of filtering ground coffee beans, and that has an engagement portion for engaging with the second extractor in order to be placed at a predetermined position from the bottom portion of the second extractor. The second filter portion is placed in the hollow portion of the second extractor so that the tube portion achieves a siphon effect.

In addition, according to a fifth aspect, there is provided a coffee production method for extracting coffee extract in the coffee extraction device according to any one of the first aspect to the third aspect. The coffee production method includes a first step of putting the ground coffee beans into the filter portion in the coffee extraction device so as to drip the water to the filter portion, a second step of soaking the coffee beans with the water dripped in the first step, a third step of extracting coffee extract by further dripping the water in the second step, and causing the coffee extract contained inside the filter portion to exceed a height of a bent portion so as to achieve the siphon effect, and a fourth step of causing a portion of the coffee extract to flow out to the lower portion by using the siphon effect, and bringing the remaining coffee extract into a stored state in a storage portion.

In addition, according to a sixth aspect, there is provided a coffee production method for extracting coffee extract in the coffee extraction device according to the fourth aspect. The coffee production method includes a first step of respectively putting the ground coffee beans into the filter portion in the coffee extraction device and the second filter portion in a second coffee extraction device so as to drip the water to the filter portion, a second step of soaking the coffee beans with the water dripped in the first step, a third step of extracting coffee extract by further dripping the water in the second step, and causing the coffee extract contained inside the filter portion to exceed a height of a bent portion so as to achieve the siphon effect, a fourth step of causing a portion of the coffee extract to flow out to the lower portion by using the siphon effect, and bringing the remaining coffee extract into a stored state in a storage portion, a fifth step of further dripping the coffee extract extracted in the fourth step to the second filter portion, a sixth step of soaking the coffee beans placed inside the second filter portion with the coffee extract dripped in the fifth step, a seventh step of further dripping the coffee extract obtained in the sixth step, and causing a second coffee extract contained inside the second filter portion to exceed the height of the bent portion in the tube portion so as to achieve the siphon effect, and an eighth step of causing a portion of the second coffee extract to flow out to the lower portion by using the siphon effect, and bringing the remaining coffee extract into a stored state in the storage portion. Incidentally, the water has been described as an example, the example includes hot water.

As described above, according to the present invention, it is possible to provide the coffee extraction device and the production method which can extract the coffee extract from which the unfavorable taste is removed as much as possible, by preventing discharge of the coffee extract extracted at the final extraction stage, that is, immediately before the water is completely dripped.

### BRIEF DESCRIPTION OF DRAWINGS

FIG. 1 is an exploded perspective view of a coffee extraction device.

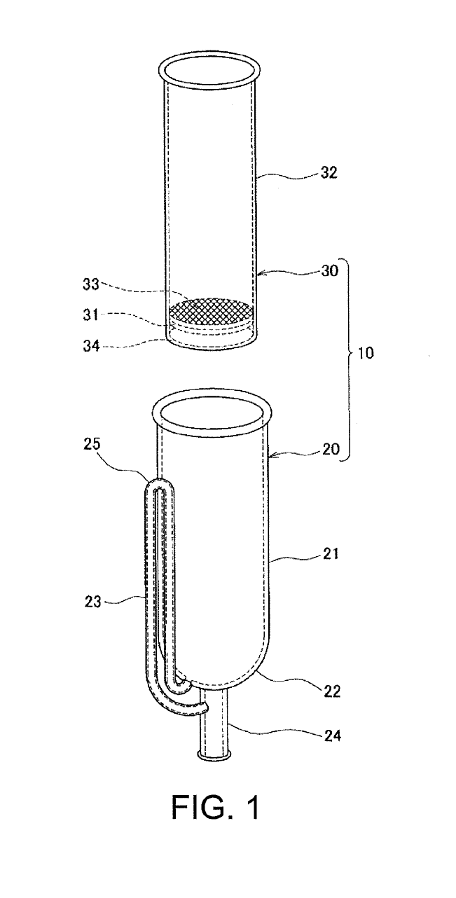

FIG. 2 is a perspective view of a dripping device.

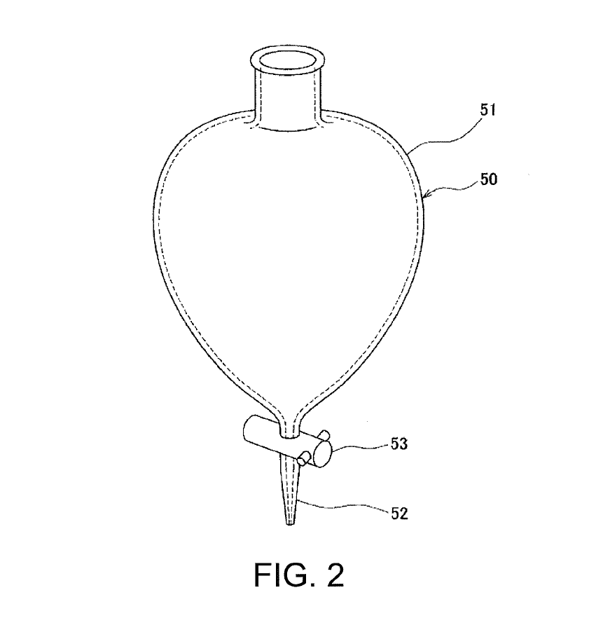

FIG. 3 is a perspective view of an air mixing device.

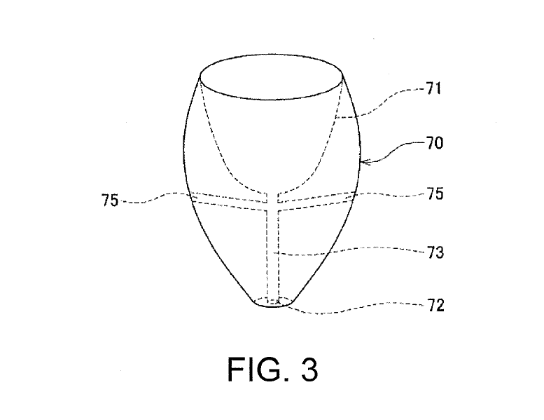

FIG. 4 is a perspective view of a coffee extraction device according to a first embodiment.

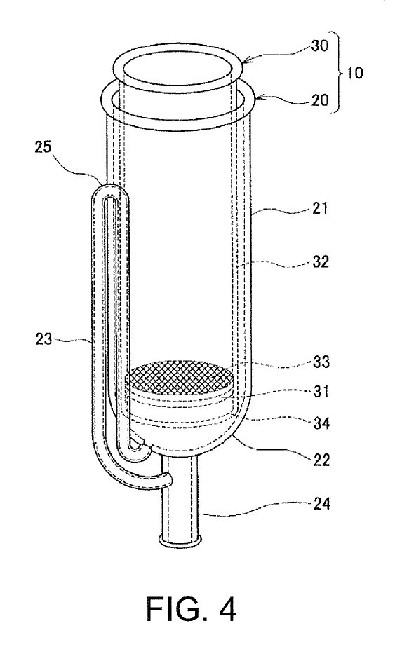

FIG. 5 is a perspective view of a coffee extraction device according to a second embodiment.

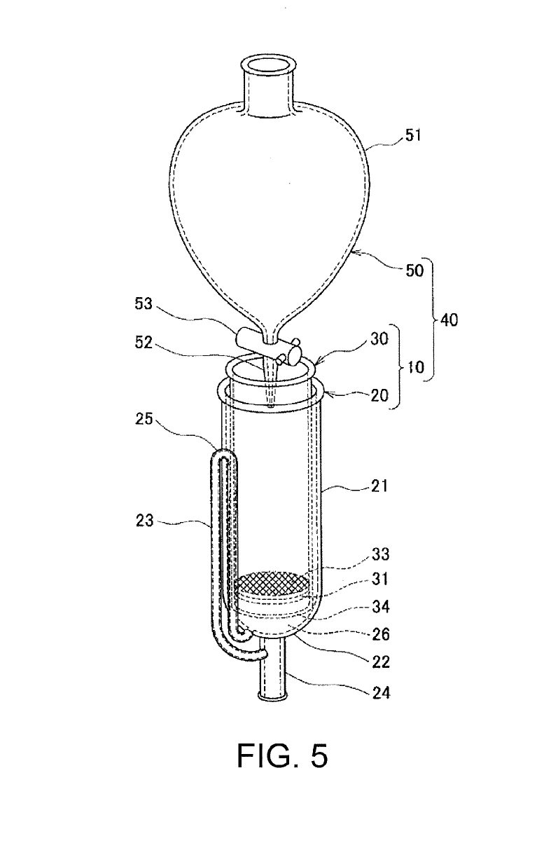

FIG. 6 is a perspective view of a coffee extraction device according to a third embodiment.

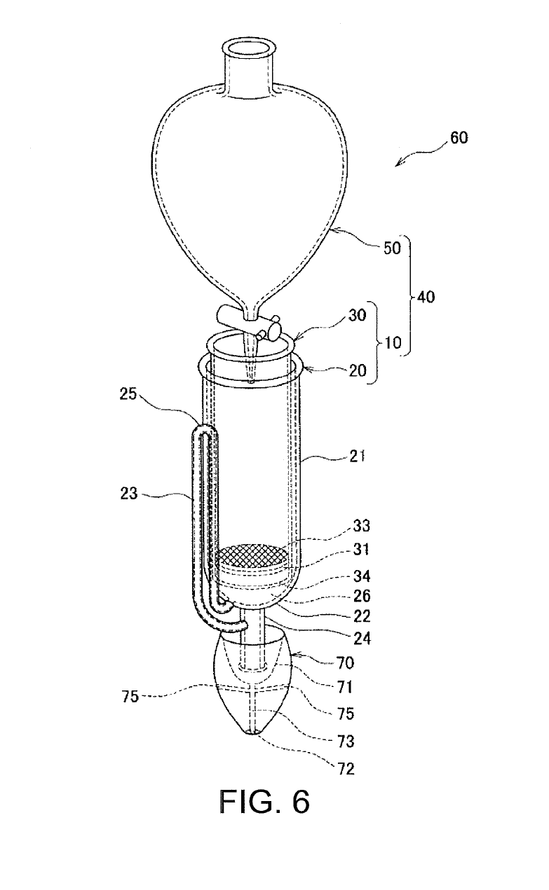

FIG. 7 is a perspective view of a coffee extraction device according to a fourth embodiment.

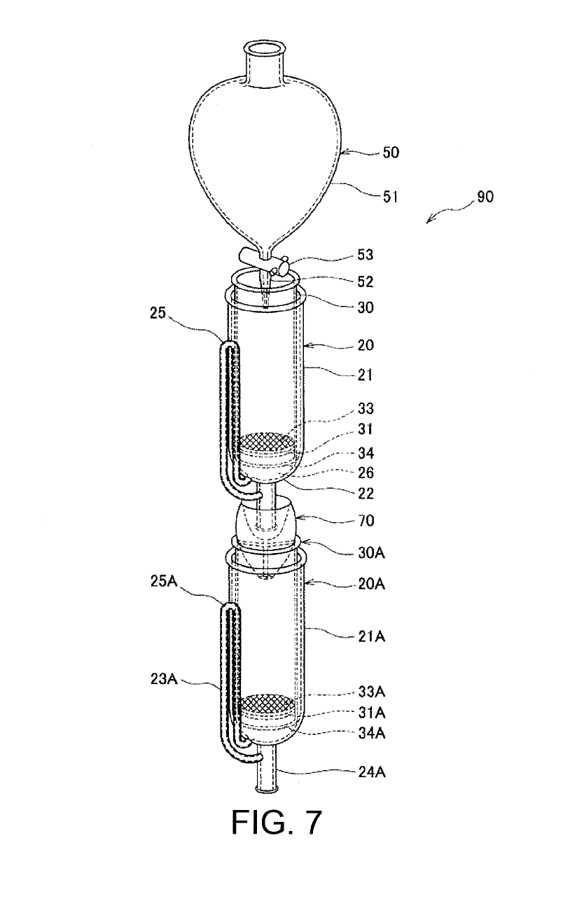

FIG. 8a illustrates a state of a first step, FIG. 8b illustrates a state of a second step, FIG. 8c illustrates a state of a third step, and FIG. 8d illustrates a state of a fourth step.

FIG. 9e illustrates a state of a fifth step, FIG. 9f illustrates a state of a sixth step, FIG. 9g illustrates a state of a seventh step, and FIG. 9h illustrates a state of an eighth step.

### DESCRIPTION OF EMBODIMENTS

Hereinafter, illustrated embodiments will be described in detail. A coffee extraction device 10 according to a first embodiment is configured to include an extractor 20 which achieves a siphon effect by itself alone and a filter portion 30 placed inside the extractor 20. The extractor 20 has a hollow portion 21 having a hollow cylindrical shape and a bottom portion 22. The bottom portion 22 prevents a liquid from flowing out, and has a configuration in which the liquid does not directly flow out from the bottom portion 22 to a lower portion 24 (to be described later).

In addition, the extractor 20 has a tube portion 23. The tube portion 23 is connected to the bottom portion 22, ascends from the bottom portion 22, and descends again via a bent portion 25. Thereafter, the tube portion 23 is connected to the lower portion 24 placed below the bottom portion 22. According to the first embodiment, the lower portion 24 has a tubular shape, and is connected to the bottom portion 22. A liquid does not directly flow out from the bottom portion 22. As will be described later, a configuration is adopted in which the liquid is discharged to the lower portion 24 via the bottom portion 22 and the tube portion 23 connected to the lower portion 24. That is, the liquid is discharged outward from the bottom portion 22 by way of the tube portion 23 and the lower portion 24. Accordingly, in a case where a filter portion 30 (to be described later) is placed, a mounting position of the bottom portion 22 and the tube portion 23 may be located below a filter 33.

The filter portion 30 has a filter mounting portion 31, and a main body 32 has a hollow cylindrical shape. In order to extract coffee extract from a ground coffee beans, the filter 33 for filtering the coffee beans is placed in the filter mounting portion 31. It is preferable that the filter 33 has a stainless steel made mesh shape. In addition, in this case, it is preferable to form a sieve opening of the mesh to such an extent that the coffee beans subjected to intermediate grinding does not pass through the sieve opening. For example, it is preferable that a size thereof is 0.2 mm to 0.5 mm, particularly 0.3 mm to 0.4 mm. As will be described later, the reason is to satisfy the following condition. When the coffee beans are ground, it is preferable that a grinding range is between the so-called intermediate grinding and the coarse grinding. In this case, the intermediate grinding is performed, for example, when roasted coffee beans are ground by setting a dial to 4.0 in the Fuji Royal Mill R-440 manufactured by Fuji Koki Inc (not illustrated). Thereafter, the coarse grinding is performed as the dial is gradually set to 8.0. In addition, if the dial is set to 10, rough grinding can be performed. As the coarse grinding is performed, it is possible to extract coffee which has relatively less unfavorable taste and a pleasant aroma. In a case of a device (to be described later, not illustrated) for producing so-called cold brew coffee in the related art, it is preferable to generally use approximately 100 grams of ground coffee beans K for 1,000 cc of the water. However, in the present embodiment, as will be described later, extraction of coffee extract W1 is promoted using approximately 40 grams of the ground coffee beans K for 1,000 cc of the water. However, as the coarse grinding is further performed, the amount of the ground coffee beans K tends to slightly increase more than the above-described numerical value. However, this is not always correct in a case where fine grinding is preferred depending on a taste.

In addition, an engagement portion 34 is placed below the filter mounting portion 31. The engagement portion 34 is installed so as to place the filter portion 30 above with a predetermined interval therebetween from the bottom portion 22 in the extractor 20 in a case where the filter portion 30 is placed inside the extractor 20. According to the present embodiment, the bottom portion 22 in the extractor 20 has a shape whose diameter decreases downward, that is, a so-called tapered shape. Therefore, as described above, even if the filter portion 30 is placed inside the extractor 20, the filter 33 is placed above without coming into contact with the bottom portion 22. In a case where the filter portion 30 is placed, as long as the filter portion 30 can be placed above with the predetermined interval therebetween from the bottom portion 22 in the extractor 20, a position, a size, and a shape of the engagement portion 34 are not particularly limited. If the filter 33 can be placed inside the filter portion, it is preferable not to provide the filter mounting portion 31.

It is found out that the amount which causes the unfavorable taste is approximately 10 cc to 20 cc of the coffee extracted in a case where the amount of water in the extractor 20 is set to 1,000 cc. Accordingly, it is preferable to place the engagement portion 34 at a position where the amount can be stored. In a case of the present embodiment, it is preferable that the filter mounting portion 31 is placed approximately 2 cm above the bottom portion 22. A storage portion 26 is defined between the bottom portion 22 and the bottom portion 31 of the filter portion 30, and the coffee which causes the unfavorable taste is stored in the storage portion 26. This configuration will be described later.

An extraction device 40 according to a second embodiment has the extractor 20 and the filter portion 30 placed therein, and has a dripping device 50 for dripping the liquid into the filter portion 30. That is, the dripping device 50 is mounted upstream of the extraction device 10 according to the first embodiment. Accordingly, the extractor 20 and the filter portion 30 placed therein are the same as those according to the above-described first embodiment 10. Thus, the same reference numerals will be given thereto, and description thereof will be omitted.

The dripping device 50 includes a dripper main body 51 which can store the liquid and an outflow portion 52 having a tubular shape in the lower portion. A dripping adjustment device 53 is disposed between the dripper main body 51 and the outflow portion 52, and can optionally adjust the amount and the interval of the liquid to be dripped. In general, as the coffee beans are roughly ground, it is preferable to decrease the amount of the water to be dripped. However, as will be described later, according to the present embodiment, compared to the so-called cold brew method for only permeation in the related art, the amount of the water can be increased.

An extraction device 60 according to a third embodiment further includes an air mixing device 70 placed therein. That is, sequentially from above, the extraction device 60 has a dripping device 50, the extractor 20, and the filter portion 30 placed therein, and the air mixing device 70 which mixes the air with the coffee extract flowing out from the lower portion 24 is placed therein. The dripping device 50 and the extractor 20 are the same as those according to the second embodiment 40. Thus, the same reference numerals will be given thereto, and description thereof will be omitted.

The air mixing device 70 has a liquid storage portion 71 in the upper portion, has an outlet tube 73 leading to a discharge port 72 of the lower portion, and is configured so that air inlet tubes 75 and 75 are placed in an intermediate portion of the outlet tube 73. If the liquid is poured into the liquid storage portion 71 in the air mixing device 70, in a process where the liquid flows out to the discharge port 72, the air introduced by the air inlet tubes 75 and 75 is mixed with the liquid in the outlet tube 73. The liquid containing the air can flow out from the discharge port 72.

An extraction device 90 according to a fourth embodiment further has an extractor 20A and a filter portion 30A placed therein. That is, sequentially from the upstream side, the extraction device 90 has a dripping device 50, the extractor 20, and the filter portion 30 placed therein, the air mixing device 70 which mixes the air with the coffee extract flowing out from the lower portion 24 is placed in the extraction device 90, and further has the extractor 20A and the filter portion 30A placed therein.

The extractor 20A and the filter portion 30A which are placed on the most downstream side are the same as those according to the first embodiment. In other words, two sets of the extractor 20 and the filter portion 30 are used. Therefore, the extractor 20A and the filter portion 30A which are the same as those in which the first embodiment 10 is further mounted on the downstream side of the third embodiment 60. The extractor 20A and the filter portion 30A have the same configuration as the extractor 20 and the filter portion 30. Thus, the reference numeral A is further affixed thereto, and description thereof will be omitted.

(Coffee Production Method of Extracting Coffee)

With regard to a coffee production method of extracting coffee using the extraction device 10 according to the first embodiment, a method of producing so-called cold brew coffee will be described. In case where the method is used for a plurality of persons, the corresponding coffee beans, the amount of water, and the extraction device 10 having the corresponding capacity are used.

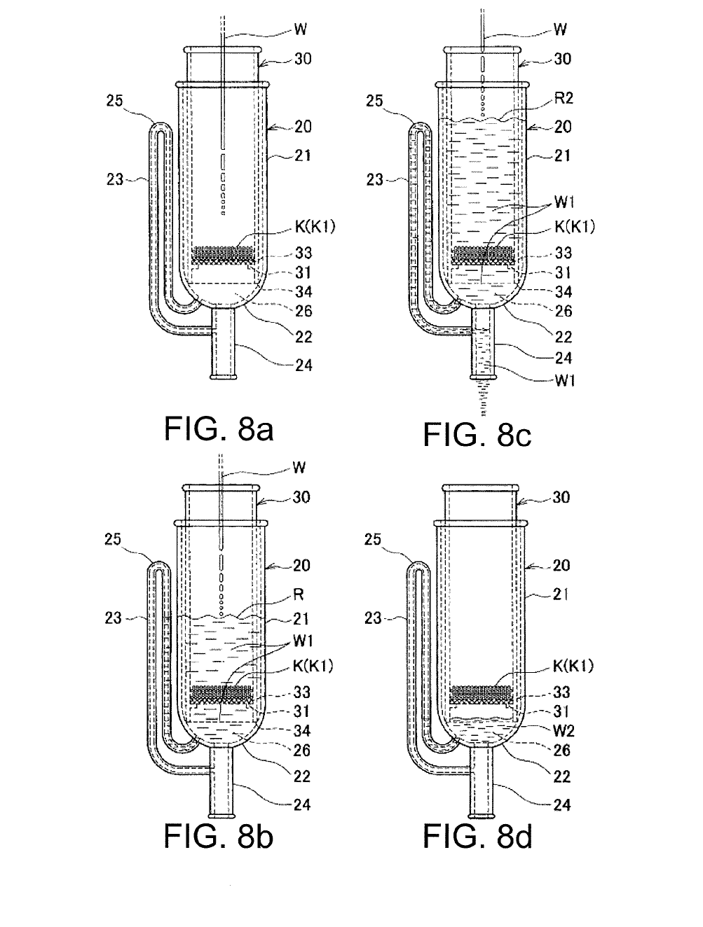

40 grams of coffee beans K which are moderately roasted and subjected to intermediate grinding or coarse grinding as described above are put into the filter portion 30. The filter portion 30 is placed inside the extractor 20. In this way, a coffee cup (not illustrated) is placed below the extraction device 10 according to the first embodiment, and water W is dripped into the filter portion 30 (first step, refer to FIG. 8a). In this case, if the so-called cold brew coffee is produced, it is possible to use normal temperature water. For 40 grams of the coffee beans K, 1,000 cc of the water is used. In this case, it is preferable that the coffee beans are subjected to dark roasting. A grain size of the coffee beans is preferably obtained through the intermediate grinding or the coarse grinding. As the coarse grinding is performed, the unfavorable taste is less extracted. As described above, the amount of the coffee beans may be increased or decreased depending on a taste.

If the water W is gradually dripped in the first step, the coffee beans K put into the filter portion 30 are gradually soaked with the water W (second step, refer to FIG. 8b). At this time, the ground coffee beans K are swollen by absorbing the water. In this case, if the normal temperature water is used instead of hot water, it is possible to comparatively prevent the unfavorable taste from being extracted.

If the water W is further dripped, a liquid level R in the filter portion 30 gradually rises, and the coffee beans K are soaked with the water, thereby promoting the extraction of coffee extract W1. At this time, the water passes through the coffee beans K, and moreover, the coffee beans K are soaked with the water, thereby promoting the extraction of the coffee. In this manner, a smaller amount of the coffee beans K is used, compared to cold brew method in the related art, and the coffee beans subjected to the coarse grinding are used as much as possible. Accordingly, while the unfavorable taste is suppressed, the extraction of the coffee extract W1 having a pleasant aroma is promoted. At the same time, the filter 33 in the filter portion 30 causes the extracted coffee extract W1 to be separated from the coffee beans K and to be stored in the storage portion 26.

In addition, a height of a liquid level R1 of the coffee extract W1 in the filter portion 30 gradually rises, and a height of a liquid level R2 in the tube portion 23 rises, thereby exceeding the height of the bent portion 25. At this time, a siphon effect occurs, and thus, the coffee extract W1 inside the filter portion 30 flows into the tube portion 23. The tube portion 23 is connected to the bottom portion 22 as described above. The tube portion 23 ascends from the bottom portion 22, and descends again via the bent portion 25. Thereafter, the tube portion 23 is connected to the lower portion 24 placed below the bottom portion 22. Accordingly, the coffee extract W1 inside the filter portion 30 flows to the lower portion 24 (third step, refer to FIG. 8c). In this way, the above-described step is repeatedly performed until there is no more water to be dripped. The coffee extract W1 is mixed up and down in the filter portion 30. Accordingly, the taste rarely varies. In addition, the coffee beans K are brought into a so-called immersed state in the coffee extract W1. Therefore, a rich flavor is added to the coffee extract W1.

Immediately before there is no more water to be dripped, in a case where a last siphon effect occurs, the coffee extract W1 inside the extractor 20 does not all flow out. Approximately 10 cc to 20 cc of coffee extract W2 in the storage portion 26 does not flow out to the lower portion 24, and is brought into a stored state in the storage portion 26. In addition, due to the siphon effect, the coffee extract W1 is caused to vigorously flow out to the lower portion 24. Therefore, the aroma of the coffee is distinctively created (fourth step, refer to FIG. 8d).

In addition, concurrently with the above-described step, the unfavorable taste may be felt from the coffee extract W2 stored in the storage portion 26 in some cases. That is, it is empirically found that at the final stage of dripping the coffee extract, there is a possibility of the unfavorable taste which is not felt from the coffee extract obtained during the dripping. Therefore, the unfavorable taste is not allowed to be discharged to the lower portion 24. In this manner, it is possible to extract the coffee extract W1 from which the unfavorable taste is removed as much as possible. Accordingly, as described above, if a coffee cup (not illustrated) placed in the lower portion 24, it is possible to make coffee having a pleasant aroma and less unfavorable taste. The coffee extract W2 is finally discarded.

As described above, approximately 10 cc to 20 cc of the coffee extract W2 in the storage portion 26 does not flow out to the lower portion 24, and is brought into a stored state in the storage portion 26. This state is achieved by the engagement portion 34 placed in the filter mounting portion 31 in the filter portion 30. That is, in a case where the filter portion 30 is placed inside the extractor 20, the filter portion 30 is placed above the engagement portion 34 with a predetermined interval from the bottom portion 22 in the extractor 20. Therefore, the storage portion 26 serving as a prescribed space is configured to exist between the filter mounting portion 31 in the filter portion 30 and the bottom portion 22 in the extractor 20. Therefore, the siphon effect is not exerted at the final stage of extracting the coffee, that is, for example, in approximately 10 to 20 cc of the coffee extract W2 except for the amount of the water absorbed by the coffee beans K out of 1,000 cc of the water. Without being discharged from the lower portion 24 of the extractor 20, approximately 10 to 20 cc of the coffee extract W2 are finally stored in the storage portion 26.

As described above, there is a possibility that the unfavorable taste may be mixed into the last 10 to 20 cc of the stored coffee extract W2. Accordingly, the last coffee extract W2 is not mixed as the coffee into the coffee cup. Therefore, a possibility that the unfavorable taste may be mixed into the coffee extract W1 is minimized as much as possible. Empirically, the unfavorable taste means bitterness or sourness. However, it is conceivable that components of oil or bubbles extracted from the coffee beans K configure to cause the unfavorable tastes.

The coffee production method of extracting the coffee by using the extraction device 40 according to the second embodiment will be described. As described above, the extraction device 40 according to the second embodiment has the extractor 20 and the filter portion 30 placed therein, and has the dripping device 50 for dripping the water to the filter portion 30. Therefore, as described above, dripping work in the extraction device 10 according to the first embodiment is carried out by the replaced dripping device 50.

The dripping device 50 can drip the water at a regular interval, and puts a required amount of the water into the dripper main body 51. In the so-called cold brew method, as described above, the amount of the water to be dripped is adjusted depending on a grinding method of the coffee beans. For example, in a case of the coarse grinding, it is preferable that one drop is dripped every three seconds. However, in a case of the intermediate grinding, one drop per second, two drops per second, or three drops per second may be continuously dripped. Any method is also preferable.

In this way, water pouring work carried out in the first embodiment is carried out by the dripping device 50. As described above, a dripping interval is adjusted depending on the grinding method of the coffee beans. For example, 1,000 cc of the water is put into the dripping device 50. Others are the same as those in the case of the extraction device 30 according to the first embodiment. Therefore, the coffee extract W1 is extracted through the same steps from the first step to the fourth step. The unfavorable taste may be felt from the coffee extract W2 stored in the storage portion 26. Therefore, the unfavorable taste is not allowed to be discharged to the lower portion 24. In this manner, it is possible to extract the coffee extract W1 from which the unfavorable taste is removed as much as possible. Accordingly, if a coffee cup (not illustrated) placed in the lower portion 24, it is possible to make coffee having a pleasant aroma and less unfavorable taste. Similarly, the coffee extract W2 is finally discarded (refer to FIGS. 8a to 8d).

In the extraction device 60 according to the third embodiment, as described above, the air mixing device 70 is further placed in the extraction device 40 according to the second embodiment. That is, sequentially from above, the extraction device 60 has the dripping device 50, the extractor 20, and the filter portion 30 placed therein, and the air mixing device 70 which mixes the air with the coffee extract W1 flowing out from the lower portion 24 is placed in the extraction device 60. In the extraction device 60 according to the above-described third embodiment, the air can be further mixed into the extracted coffee extract W1. In this case, the taste of the coffee becomes mild. However, a user can drip the water at a regular intervals without using the dripping device 50 (not illustrated).

As the coffee production method of extracting the coffee by using the extraction device 60 according to the third embodiment, the air mixing device 70 is further placed in the extraction device 40 according to the second embodiment. As described above, for example, 1,000 cc of the water is put into the dripping device 50. Others are the same as those in the case of the extraction device 30 according to the first embodiment. Therefore, the coffee extract W1 is extracted through the same steps from the first step to the fourth step. In addition, the unfavorable taste may be felt from the coffee extract W2 stored in the storage portion 26. Therefore, the unfavorable taste is not allowed to be discharged to the lower portion 24. In this manner, it is possible to extract the coffee extract W1 from which the unfavorable taste is removed as much as possible. In addition, the air mixing device 70 which mixes the air with the coffee extract W1 flowing out from the lower portion 24 is further placed. In the extraction device 60 according to the above-described third embodiment, the air can be further mixed with the extracted coffee extract W1. Accordingly, if a coffee cup (not illustrated) placed in the air mixing device 70, it is possible to make coffee having a pleasant aroma and less unfavorable taste. Similarly, the coffee extract W2 is finally discarded (refer to FIGS. 8a to 8d).

In this way, the storage portion 26 serving as a prescribed a certain space is configured to exist between the filter 33 in the filter portion 30 and the bottom portion 22 in the extractor 20. Therefore, the siphon effect is not exerted at the final stage of extracting the coffee, that is, for example, in approximately 10 to 20 cc of the coffee extract except for the amount of the water absorbed by the coffee beans K out of 1,000 cc of the water. Without being discharged from the lower portion 24 of the extractor 20, approximately 10 to 20 cc of the coffee extract are finally stored in the storage portion 26. There is a possibility that the unfavorable taste may be mixed into the last 10 to 20 cc of the stored coffee extract W2. Accordingly, the last coffee extract W2 is not mixed as the coffee into the coffee cup through the air mixing device 70. Therefore, similarly, a possibility that the unfavorable taste may be mixed into the coffee extract is minimized as much as possible.

In the extraction device 90 according to the fourth embodiment, the extractor 20 and the filter portion 30 are further placed in the extraction device according to the third embodiment. That is, a configuration is adopted in which the dripping device 50, the first extractor 20, and the filter portion 30 are placed, the air mixing device 70 is further placed therein, and the second extractor 20A and the filter portion 30A are further placed therein from the upstream side.

As the coffee production method of extracting the coffee by using the extraction device 90 according to the fourth embodiment, a portion of coffee beans K1 of the ground coffee beans K is placed in the filter portion 30 inside the first extractor 20, and the remaining coffee beans K2 are placed in the filter portion 30A inside the second extractor 20A. For example, 35 grams of the coffee beans K1 from 40 grams of the ground coffee beans K for one person are placed in the filter portion 30 inside the first extractor 20, and the remaining 5 grams of the coffee beans K2 are placed in the filter portion 30A inside the second extractor 20A. The first extractor 20 and the filter portion 30 may preferably have the same capacity as the second extractor 20A and the filter portion 30A.

A proper amount of normal temperature water is put into the dripping device 50, and the first step to the fourth steps are performed as described above (FIGS. 8a to 8d, refer to the reference numeral K1). In the above-described first step, the water W is dripped to the filter portion 30 inside the first extractor 20 at a regular interval. For example, in a case where 1,000 cc of the normal temperature water W is put into the dripping device 50, at the final stage of extracting the coffee extract W1 in the first extractor 20, that is, in a state where 1,000 cc of the above-described normal temperature water is completely dripped, a portion of 1,000 cc of the water W is absorbed by the ground coffee beans, and approximately 900 cc of the water W is extracted. Approximately 10 to 20 cc of the coffee extract W2 are stored in the storage portion 26. Therefore, the siphon effect is not exerted at the final stage of extracting the coffee, that is, for example, in approximately 10 to 20 cc of the coffee extract W2 except for the amount of the water absorbed by the coffee beans K1 out of 1,000 cc of the water. Without being discharged from the lower portion 24 of the extractor 20, approximately 10 to 20 cc of the coffee extract W2 is finally stored in the storage portion 26. There is a possibility that the unfavorable taste may be mixed into the last 10 to 20 cc of the stored coffee extract W2. Accordingly, the last coffee extract W2 is not discharged from the lower portion 24. Therefore, except for approximately 100 cc absorbed by the coffee beans K1, approximately 880 cc to 890 cc of the coffee extract W1 flows into the air mixing device 70.

The air is mixed into approximately 880 cc to 890 cc of the coffee extract W1 flowing into the air mixing device 70. 880 cc to 890 cc of the coffee extract W1 is dripped again to the filter portion 30A in the second extractor 20A.

As described above, approximately 5 grams of the ground coffee bean powder K2 is put into the second filter portion 30A. Accordingly, a portion of 880 cc to 890 cc of the coffee extract W1 is absorbed by the coffee bean powder K2, and a coffee aroma is further added thereto, thereby extracting approximately 860 cc of a second coffee extract W3.

However, the configuration of the second extractor 20A and the filter portion 30A is the same as that of the first extractor 20 and the filter portion 30. Accordingly, a prescribed amount of the remaining coffee extract W4 in the above-described second coffee extract W3 is stored in the storage portion 26A. Therefore, here, the coffee extract W4 containing the unfavorable taste such as bitterness or sourness is stored in the storage portion 26A, and a possibility that the unfavorable taste may be mixed into the second coffee extract W3 is eliminated as much as possible. Therefore, the second coffee extract W3 is finally extracted, and the extracted amount is approximately 840 cc.

In this way, the ground coffee beans K1 and K2 are respectively put into the filter portion 30 and the second filter portion 30A, and the fifth step to the eighth step which are described above are further performed this time using the coffee extract W1 extracted in the fourth step instead of the water W. In this manner, the fifth step to the eighth step which are substantially the same as the steps from the first step to the fourth step are repeatedly performed.

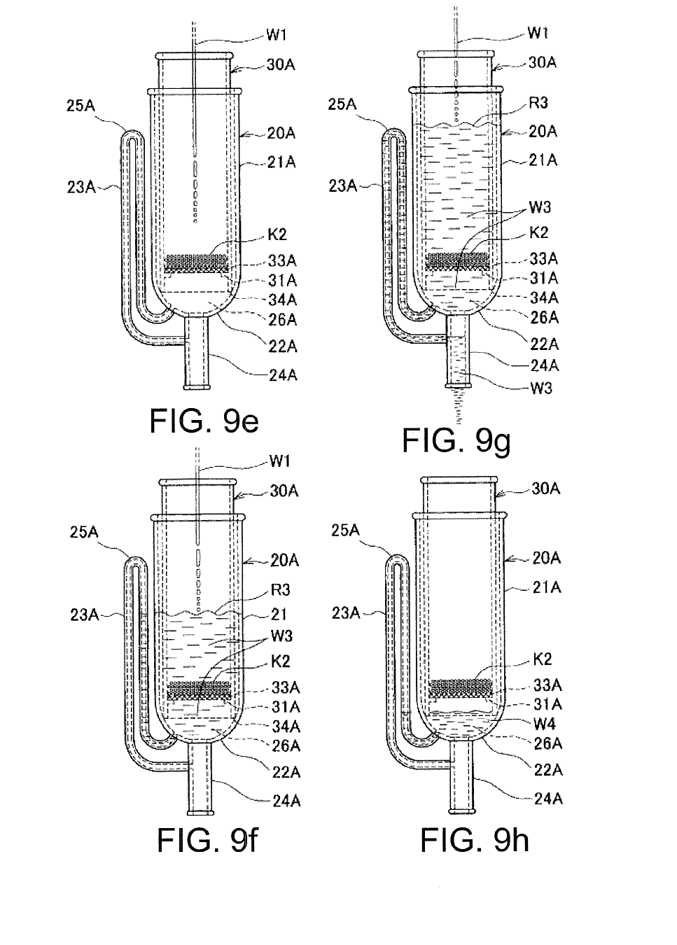

That is, the coffee extract W1 flowing out in the fourth step is dripped to the second filter portion 30A (refer to FIG. 9e, fifth step). In addition, in the fifth step in which the coffee extract W1 dripped in this way soaks the coffee beans K2 placed in the second filter portion 30A (refer to FIG. 9f, sixth step), the coffee extract W1 is further dripped. In this manner, the coffee extract is extracted, thereby obtaining the second coffee extract W3. In addition, the height of the liquid level R3 of the second coffee extract W3 in the filter portion 30A gradually rises, and the height of the liquid level R4 in the tube portion 23A rises, thereby exceeding the height of the bent portion 25A. Accordingly, the siphon effect is exerted (refer to FIG. 9g, seventh step). If the siphon effect is exerted before there is no more coffee extract W1 to be dripped, in a case where the last siphon effect is exerted before there is no more coffee extract to be dripped, the second coffee extract W3 in the extractor 20A does not all flow out. Approximately 10 cc to 20 cc of the coffee extract W4 stored in the storage portion 26A does not flow to the lower portion 24A, and is brought into a stored state in the storage portion 26A (refer to FIG. 9h, eighth step). These steps are sequentially performed. In this manner, the second coffee extract W3 finally flowing out from the lower portion 24A is obtained by extracting the coffee twice. Accordingly, the second coffee extract W3 having a rich aroma can be produced. In this way, the above-described processes are repeatedly performed until there is no more water to be dripped. The coffee extract W3 is mixed up and down in the filter portion 30A. Accordingly, the taste rarely varies. In addition, the coffee beans K2 are brought into a so-called immersed state in the coffee extract W1. Therefore, a rich flavor is added to the coffee extract W3.

It is possible to use a support device which supports the extraction device 10 according to the first embodiment, the extraction device 40 according to the second embodiment, the extraction device 60 according to the third embodiment, and the extraction device 70 according to the fourth embodiment (not illustrated).

Here, the results obtained through comparison tests by using the extraction device 10 according to the first embodiment and the so-called cold brew method in the related art will be described. In both cases, for 800 cc of the water, roasted coffee beans are ground by setting a dial to 6.0 in the Fuji Royal Mill R-440 manufactured by Fuji Koki Inc. In this case, the ground coffee powder weighs 40 grams. In order to easily obtain the unfavorable taste, the amount of the water is reduced relative to the amount of the coffee powder.

Here, a water dripper WD-300 manufactured by Oji Co. Ltd. is used as a device for producing cold brew coffee in the related art. This coffee is produced as follows. The water is put into a so-called a water ball, and the water is dripped from a level cock placed in the lower portion of the water ball. Furthermore, a filter is placed into a funnel placed in the lower portion, and the ground coffee powder is put into the filter. The water is dripped from the above-described level cock so as to extract a coffee extract.

This test is carried out for 5 persons including 3 men and 2 women. Coffee A extracted by the extraction device 10 according to the first embodiment and coffee B extracted by the device in the related art as a comparative example are respectively tested. The results are illustrated in the following table. Here, the coffee A represents the above-described coffee extract W1. In this way, a result that A has less unfavorable taste than B is obtained from 4 out of 5 persons. Nobody answers that B has less unfavorable taste than A.

| | Test Results | Number of Persons |
|---|---|---|
| 1 | No difference is felt between A and B | 1 persons |
| 2 | A has less unfavorable taste than B | 4 persons |
| 3 | B has less unfavorable taste than A | 0 persons |

In addition, the following table shows answers to what extent the unfavorable taste is felt are received from 4 persons who answer that A has less unfavorable taste than B in the answer 2 shown above.

| | Test Results | Number of Persons |
|---|---|---|
| 1 | A has less unfavorable taste than B, | 2 persons |
| | but relatively a small difference | |
| 2 | Difference in unfavorable tastes is | 2 persons |
| | obviously felt between A and B | |

In this way, the comparison tests are carried out using the extraction device 10 according to the first embodiment and the so-called cold brew method in the related art. As a result, a fact is obtained in that the coffee A extracted in the extraction device 10 according to the first embodiment has less unfavorable taste. The reason is conceivable as follows. According to the so-called cold brew method in the related art, the unfavorable taste is mixed into the coffee extract extracted by the last dripped water. Therefore, in a case of the device according to the present embodiment, it is possible to eliminate the coffee extract extracted by the last dripped water which is considered to have the unfavorable taste mixed therein. Accordingly, it is conceivable that the above-described result is obtained. When the coffee extract is actually extracted, it is possible to use the amount of the coffee bean powder, for example, 40 grams of the ground coffee bean powder for 1,000 cc of the water. In addition, the ground coffee beans are brought into a so-called immersed state in the coffee extract. Accordingly, it is possible to sufficiently extract the coffee extract from the smaller amount of the coffee beans, compared to the amount used in the related art. Furthermore, it is possible to extract the coffee having much less unfavorable taste.

### REFERENCE SIGNS LIST

10, extraction device according to first embodiment
20, extractor
20A, second extractor
21, 21A, hollow portion
22, 22A, bottom portion
23, 23A, tube portion
24, 24A, lower portion
25, 25A, bent portion
30, filter portion
30A, second filter portion
31, 31A, filter mounting portion
33, 33A, filter
34, 34A, engagement portion
40, extraction device according to second embodiment
50, dripping device
60, extraction device according to third embodiment
70, air mixing device
90, extraction device according to fourth embodiment

1. A coffee extraction device, comprising:
an extractor that has a hollow portion which has an internal space for containing a liquid, a bottom portion which is disposed below the hollow portion, and a tube portion which ascends from the bottom portion and descends again so as to discharge the liquid to a lower portion of the bottom portion; and
a filter portion that is capable of filtering ground coffee beans, and that has an engagement portion for engaging with the extractor in order to be placed at a predetermined position from the bottom portion of the extractor,
wherein the filter portion is placed in the hollow portion of the extractor so that the tube portion achieves a siphon effect.

2. The coffee extraction device according to claim 1, wherein
a dripping device for dripping water at a regular interval is placed in the filter portion placed inside the extractor.

3. The coffee extraction device according to claim 1, wherein
a mixing device capable of mixing air into the liquid is disposed downstream of the coffee extraction device.

4. The coffee extraction device according to claim 3, wherein
in a lower portion of the mixing device capable of mixing the air into the liquid, further comprising:
a second extractor that has a hollow portion which has an internal space for containing a liquid, a bottom portion which is disposed below the hollow portion, and a tube portion which ascends from the bottom portion and descends again so as to discharge the liquid to a lower portion of the bottom portion; and
a second filter portion that is capable of filtering ground coffee and that has an engagement portion for engaging with the extractor in order to be placed at a predetermined position from the bottom portion of the extractor,
wherein the second filter portion is placed in the hollow portion of the second extractor so that the tube portion achieves a siphon effect.

5. A coffee production method for extracting coffee extract in the coffee extraction device according to claim 1, the coffee production method comprising:
a first step of putting the ground coffee beans into the filter portion in the coffee extraction device so as to drip the water to the filter portion;
a second step of soaking the coffee beans with the water dripped in the first step;
a third step of extracting coffee extract by further dripping the water in the second step, and causing the coffee extract contained inside the filter portion to exceed a height of a bent portion in the tube portion so as to achieve the siphon effect; and
a fourth step of causing a portion of the coffee extract to flow out to the lower portion by using the siphon effect, and bringing a remaining coffee extract into a stored state in a storage portion.

6. A coffee production method for extracting coffee extract in the coffee extraction device according to claim 4, the coffee production method comprising:
a first step of respectively putting the ground coffee beans into the filter portion in the coffee extraction device and the second filter portion in a second coffee extraction device so as to drip the water to the filter portion;
a second step of soaking the coffee beans with the water dripped in the first step;
a third step of extracting coffee extract by further dripping the water in the second step, and causing the coffee extract contained inside the filter portion to exceed a height of a bent portion in the tube portion so as to achieve the siphon effect;
a fourth step of causing a portion of the coffee extract to flow out to the lower portion by using the siphon effect, and bringing a remaining coffee extract into a stored state in a storage portion;
a fifth step of further dripping the coffee extract extracted in the fourth step to the second filter portion;
a sixth step of soaking the coffee beans placed inside the second filter portion with the coffee extract dripped in the fifth step;
a seventh step of further dripping the coffee extract obtained in the sixth step, and causing a second coffee extract contained inside the second filter portion to exceed the height of the bent portion in the tube portion so as to achieve the siphon effect; and
an eighth step of causing a portion of the second coffee extract to flow out to the lower portion by using the siphon effect, and bringing the remaining coffee extract into the stored state in the storage portion.

7. The coffee extraction device according to claim 2, wherein
a mixing device capable of mixing air into the liquid is disposed downstream of the coffee extraction device.

8. A coffee production method for extracting coffee extract in the coffee extraction device according to claim 2, the coffee production method comprising:
a first step of putting the ground coffee beans into the filter portion in the coffee extraction device so as to drip the water to the filter portion;
a second step of soaking the coffee beans with the water dripped in the first step;
a third step of extracting coffee extract by further dripping the water in the second step, and causing the coffee extract contained inside the filter portion to exceed a height of a bent portion in the tube portion so as to achieve the siphon effect; and
a fourth step of causing a portion of the coffee extract to flow out to the lower portion by using the siphon effect, and bringing a remaining coffee extract into a stored state in a storage portion.

9. A coffee production method for extracting coffee extract in the coffee extraction device according to claim 3, the coffee production method comprising:
a first step of putting the ground coffee beans into the filter portion in the coffee extraction device so as to drip the water to the filter portion;
a second step of soaking the coffee beans with the water dripped in the first step;
a third step of extracting coffee extract by further dripping the water in the second step, and causing the coffee extract contained inside the filter portion to exceed a height of a bent portion in the tube portion so as to achieve the siphon effect; and
a fourth step of causing a portion of the coffee extract to flow out to the lower portion by using the siphon effect, and bringing a remaining coffee extract into a stored state in a storage portion.
